(19) United States
(12) Patent Application Publication
(10) Pub. No.: US 2013/0293768 A1
(43) Pub. Date: Nov. 7, 2013

(54) IMAGING APPARATUS, IMAGING METHOD, IMAGING PROGRAM AND COMPUTER READABLE INFORMATION RECORDING MEDIUM

(71) Applicant: Kazuya Niyagawa, Kanagawa (JP)

(72) Inventor: Kazuya Niyagawa, Kanagawa (JP)

(21) Appl. No.: 13/978,574

(22) PCT Filed: Jan. 13, 2012
(86) PCT No.: PCT/JP12/51138

§ 371 Date: Jul. 8, 2013

(30) Foreign Application Priority Data
Jan. 17, 2011 (JP) 2011-006939
Sep. 30, 2011 (JP) 2011-217683

(51) Int. Cl. H04N 5/232

(52) U.S. Cl. CPC H04N 5/23212
USPC 348/346

(57) ABSTRACT

An imaging apparatus has an imaging part including an image sensor; a focusing control part configured to drive an optical system included in the imaging part, input an image of a subject into a light reception part of the image sensor, obtain an automatic focusing evaluation value based on the image obtained through the imaging part and carry out focusing control; and a distance measuring part configured to measure a distance to the subject using plural two-dimensional sensors. The focusing control part carries out focusing control in a case where a position of the subject is outside a distance-measurement-available-area of the distance measuring part.

### TECHNICAL FIELD

The present invention relates to an imaging apparatus, an imaging method, an imaging program and a computer readable information recording medium. In particular, the present invention relates to an imaging apparatus, an imaging method, an imaging program and a computer readable information recording medium, which, even in a case where a two-dimensional distance measuring sensor is used, prevent a situation in which focusing on a subject becomes impossible by the subject being outside a distance-measurement-available-area of the distance measuring sensor which causes the distance measurement to be unavailable. (The distance-measurement-available-area is an area where the distance measurement is available by the two-dimensional distance measuring sensor.)

### BACKGROUND ART

In the related art, as a distance measuring apparatus and a photometric apparatus of an external type, a method is known in which, for example, a pair of line sensors are used for a distance measuring purpose and a multi-segment sensor is used for a photometric purpose. The pair of line sensors are combined with a pair of lenses, respectively, thereby two cameras are obtained. Then, the difference of a subject between the two cameras (i.e., parallax) is detected, and a distance is measured according to the principle of triangulation.

In the related art, on one semiconductor chip, a pair of distance measuring line sensors and a photometric sensor, having a large size is formed. At this time, the respective sensors are disposed on the semiconductor chip in such a manner that the center lines of the sensors are offset. Thereby, it is possible to reduce the size of the semiconductor chip, and thus, it is possible to miniaturize the distance measuring apparatus and the photometric apparatus (for example, see Japanese Patent No. 4217491 (Patent Document 1)).

Further, in the related art, a technique (called hybrid AF) for a camera using an automatic focusing apparatus is discussed which uses both a multi-point external AF (automatic focusing) using a line sensor and an internal multi-point AF (contrast AF) (for example, see Japanese Laid-Open Patent Application No. 2001-221945 (Patent Document 2)). It is noted that the above-mentioned “contrast AF” means AF according to a “hill-climbing method” using a charge-coupled device (CCD) or such.

### SUMMARY OF INVENTION

In an aspect, there is provided an imaging apparatus having an imaging part including an image sensor; a focusing control part configured to driving an optical system included in the imaging part, input an image of a subject into a light reception part of the image sensor, obtain an automatic focusing evaluation value based on the image obtained through the imaging part and carry out focusing control; and a distance measuring part configured to measure a distance to the subject by using plural two-dimensional sensors. The focusing control part carries out the focusing control in a case where a position of the subject is outside a distance-measurement-available-area of the distance measuring part.

Other objects, features and advantages of the present invention will become more apparent from the following detailed description when read in conjunction with the accompanying drawings.

### BRIEF DESCRIPTION OF DRAWINGS

FIGS. 1A, 1B and 1C show one example of an external appearance of an imaging apparatus applicable to any one of embodiments 1 through 6 of the present invention;

FIG. 2 shows one example of an internal system configuration of the imaging apparatus shown in FIG. 1;

FIG. 3 shows one example of a functional configuration of a CPU block shown in FIG. 2;

FIG. 4 shows a flowchart of one example of an operation procedure of the imaging apparatus;

FIG. 5 illustrates one example of an AF area;

FIG. 6 illustrates one example of a narrow-area AF area at a time of tracking AF;

FIG. 7 shows a flowchart of one example of a tracking AF procedure;

FIG. 8 illustrates one example of a distance measuring method;

FIG. 9 shows a flowchart of one example of a tracking AF procedure according to the embodiment 1 of the present invention;

FIG. 10 shows a flowchart of one example of a tracking AF procedure according to the embodiment 2 of the present invention;

FIG. 11 illustrates a distance-measurement-available-area at a time of “WIDE” mode;

FIG. 12 shows a flowchart of one example of a tracking AF procedure according to the embodiment 3 of the present invention;

FIG. 13 shows a flowchart of one example of a tracking AF procedure according to the embodiment 4 of the present invention;

FIG. 14 illustrates one example of a method of estimating a distance measurement result; and

FIG. 15 shows a flowchart of one example of a tracking AF procedure according to the embodiment 5 of the present invention.

### DESCRIPTION OF EMBODIMENTS

According to the above-mentioned configurations of the Patent Document 1 and Patent Document 2, distance measuring is carried out using the line sensors. Therefore, only the distance to the center of a field of view can be measured, and distance measuring for the entirety of a monitor screen (multi-point distance measuring) cannot be carried out.

Further, in a case where a two-dimensional sensor is used as a distance measuring sensor by which distance measuring for a wide area can be carried out, it is possible to carry out distance measuring of the entirety of a monitor screen. However, for the purpose of carrying out distance measuring for a wide area of the monitor screen, the angle of view may not be coincident between a photographing area of main lenses (camera lenses) and a distance-measurement-available-area of a distance measuring sensor in a case of zooming, for example. Thereby, a subject may be outside the distance-measurement-available-area of the distance measuring sensor and distance measuring may become impossible. Such a problem is unique to a case of using such a two-dimensional sensor.

The embodiments of the present invention have been devised in consideration of the above-mentioned problem, and an object of the embodiments is to provide an imaging apparatus, an imaging method, an imaging program and a computer readable information recording medium, which, even when a two-dimensional sensor is used as a distance measuring sensor, prevent a situation in which focusing on a subject becomes impossible by the subject being outside a distance-measurement-available-area of the distance measuring sensor which causes the distance measurement to be unavailable.

According to the embodiments of the present invention, when a two-dimensional sensor is used as a distance measuring sensor, contrast AF is used. Thereby, it is possible to prevent a situation in which focusing on a subject becomes impossible by the subject being outside a distance-measurement-available-area of the distance measuring sensor which causes the distance measurement to be unavailable. Specifically, for example, distance measuring information of the tracking subject is obtained from the distance measuring sensor at a time of tracking AF, and based on the thus obtained distance measuring information, focusing on the subject is carried out accurately. Below, the embodiments of an imaging apparatus, an imaging method, an imaging program and a computer readable information recording medium according to the present invention will be described.

### <External Appearance of Imaging Apparatus>

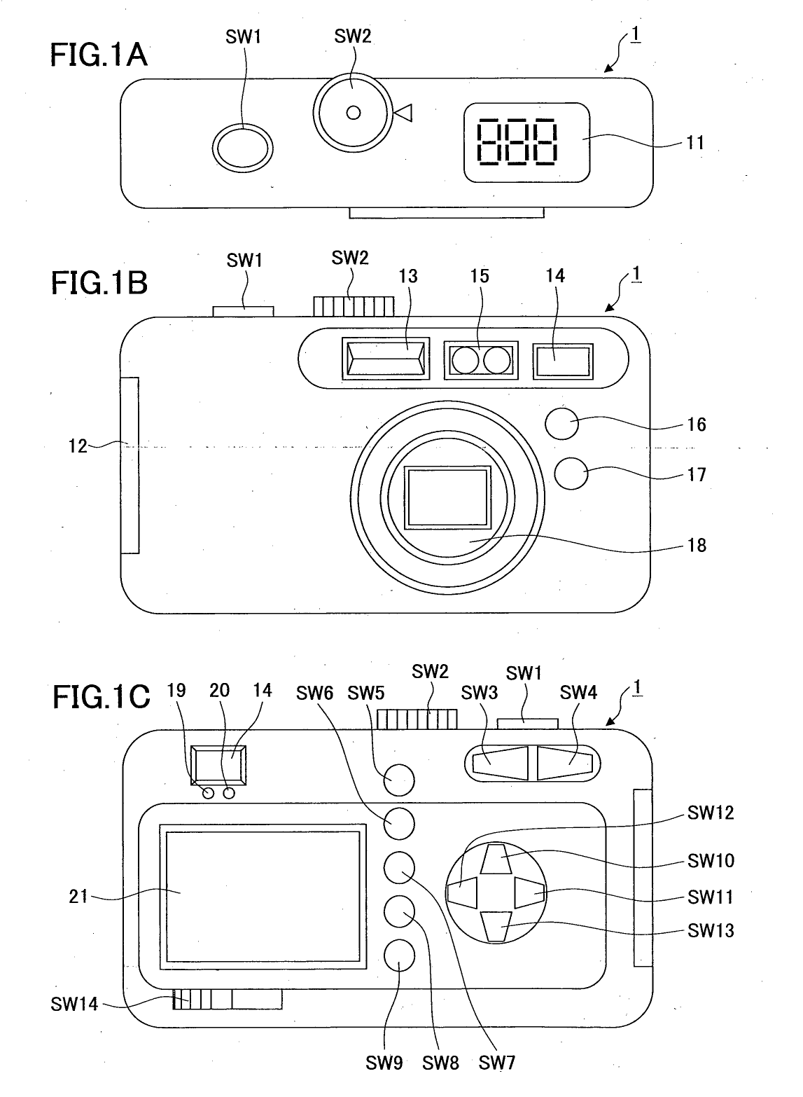

First, an imaging apparatus applicable to any one of the embodiments of the present invention will be described using figures. FIGS. 1A, 1B and 1C show one example of an external appearance of an imaging apparatus applicable to any one of the embodiments 1 through 6 of the present invention. FIG. 1A shows one example of a plan view of the imaging apparatus; FIG. 1B shows one example of a front view of the imaging apparatus; and FIG. 1C shows one example of a back view of the imaging apparatus. It is noted that in this example, a digital camera will be described as one example of an imaging apparatus. However, imaging apparatuses according to embodiments of the present invention are not limited thereto, and further, a shape, a layout and so forth of a configuration are not limited thereto, and may be determined freely according to the scope of the present invention

The imaging apparatus 1 shown in FIGS. 1A, 1B and 1C includes a sub-liquid crystal display (sub-LCD) 11, a memory card and battery loading part 12, a strobe light emitting part 13, an optical finder 14, a distance measuring unit 15, a remote control light reception part 16, an AF (automatic focusing) auxiliary light emitting device part 17, a lens barrel unit 18, an AF LED 19, a strobe LED 20, a LCD monitor 21 and switches SW1 through SW14.

### <Internal System Configuration Example of Imaging Apparatus>

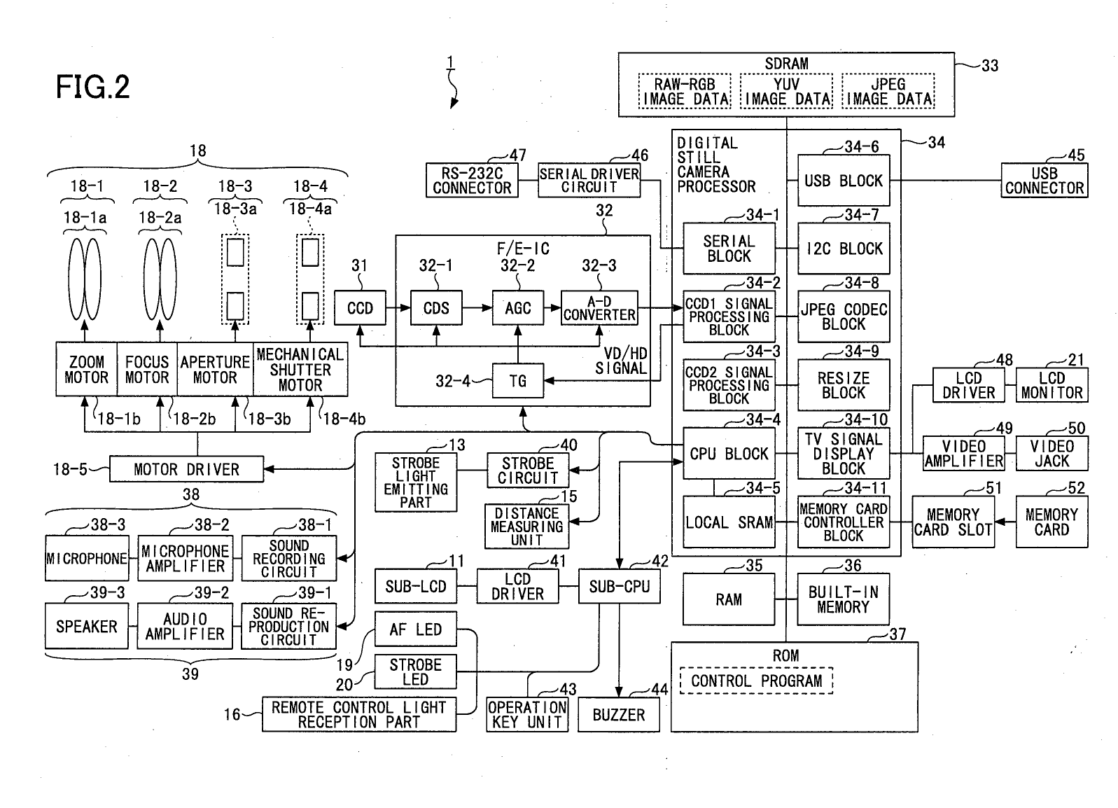

Further, FIG. 2 shows one example of an internal system configuration of the imaging apparatus according to the embodiments. The imaging apparatus 1 shown in FIG. 2 is configured to have the sub-LCD 11, the strobe light emitting part 13, the distance measuring unit 15, the remote control light reception part 16, the lens barrel unit 18, the AF LED 19, the strobe LED 20, the LCD monitor 21, a charge coupled device (CCD) 31, a F/E-IC 32, a synchronous dynamic random access memory (SDRAM) 33, a digital still camera processor (hereinafter, simply referred to as a “processor”) 34, a random access memory (RAM) 35, a built-in memory 36, a read only memory (ROM) 37, a sound input unit 38, a sound reproduction unit 39, a strobe circuit 40, a LCD driver 41, a sub-central processing unit (sub-CPU) 42, an operation key unit 43, a buzzer 44, a universal serial bus (USB) connector 45, a serial driver circuit 46, a RS-232C connector 47, a LCD driver 48, a video amplifier 49, a video jack 50, a memory card slot 51 and a memory card 52.

Further, in FIG. 2, the lens barrel unit 18 has a zoom optical unit 18-1 including a zoom lens 18-1a and a zoom motor 18-1b; a focus optical unit 18-2 including a focus lens 18-2a and a focus motor 18-2b; an aperture unit 18-3 including an aperture 18-3a and an aperture motor 18-3b; a mechanical shutter unit 18-4 including a mechanical shutter 18-4a and a mechanical shutter motor 18-4b; and a motor driver 18-5.

Further, in FIG. 2, the front end integrated circuit (F/E-IC) 32 includes a correlated double sampling unit (CDS) 32-1, an automatic gain control unit (AGC) 32-2, an analog-to-digital (A-D) converter 32-3, and a timing generator (TG) 32-4. The CDS 32-1 carries out correlation double sampling for removing image noise. The AGC 32-2 carries out automatic gain control. The A-D converter 32-2 carries out analog-to-digital conversion. The TG 32-4 generates a driving timing signal based on a vertical synchronization signal (VD) and a horizontal synchronization signal (HD).

Further, in FIG. 2, the processor 34 includes a serial block 34-1, a CCD1 signal processing block 34-2, a CCD2 signal processing unit 34-3, a CPU block 34-4, a local static random access memory (SRAM) 34-5, a USB block 34-6, an inter integrated circuit (I2C) block 34-7, a JPEG coding block 34-8, a resize block 34-9, a TV signal display unit 34-10 and a memory card controller block 34-11. These respective blocks 34-1 through 34-11 are mutually connected by bus lines. The JPEG coding block 34-8 carries out JPEG compressing and decompression. The resize block 34-9 carries out magnification and reduction of the size of the image data.

Further, in FIG. 2, the sound input unit 38 is configured to have a sound recording circuit 38-1, a microphone amplifier 38-2 and a microphone 38-3. Further, in FIG. 2, the sound reproduction unit 39 is configured to have a sound reproduction circuit 39-1, an audio amplifier 39-2 and a speaker 39-3.

The imaging apparatus 1 shown in FIGS. 1A, 1B, 1C and 2 has a function as a digital camera. Specifically, as shown in FIG. 1A, on the top of the imaging apparatus 1, the sub-LCD 11, the release switch SW1, and a mode dial SW 2 are provided.

Further, as shown in FIG. 1B, on a side part of the imaging apparatus 1, a lid of the memory card and battery loading part 12 is provided. In the memory card and battery loading part 12, the memory card slot 51 is provided (see FIG. 2), to which the memory card 52 is inserted. The memory card 52 is used for storing image data of images photographed by the imaging apparatus 1. Also a battery (not shown) is loaded in the memory card and battery loading part 12. The battery is used to turn on the power supply to the imaging apparatus 1, and drives the series of systems included in the imaging apparatus 1. Further, on the front side of the imaging apparatus 1 (see FIG. 1B), the strobe light emitting part 13, an optical finder 14, the distance measuring unit 15, the remote control light reception part 16, the AF auxiliary light emitting device part 17 and the lens barrel unit 18 are provided. The strobe light emitting part 13 includes a strobe light (not shown) used to emit light at a time of photographing. The optical finder 14 is used to visually determine the position of a subject through an optical lens. The remote control light reception part 16 receives a remote control signal of infrared ray or such, transmitted by a separate remote control apparatus (not shown). The AF auxiliary light emitting device part 17 includes an LED or such to emit light at a time of automatic focusing. The lens barrel unit 18 includes the photographing lenses (camera lenses).

Further, as shown in FIG. 1C, on the back side of the imaging apparatus 1, the optical finder 14, the AF LED 19, the strobe LED 20, the LCD monitor 21, a switch SW3 for wide-angle zooming (WIDE), a switch SW4 for telephoto zooming (TELE), a switch SW5 for setting or cancelling the setting of a self-timer, a switch SW6 for selecting from a menu, a switch SW10 for moving a AF frame (described later) on a monitor screen (LCD monitor 2) upward or setting the strobe light, a switch SW11 for moving the AF frame on the monitor screen rightward, a switch SW9 for turning on/off of the monitor screen, a switch SW13 for moving the AF frame on the monitor screen downward or setting a macro function, a switch SW12 for moving the AF frame on the monitor screen leftward or checking a photographed image, a switch SW7 for inputting an approving intension (OK), a switch SW8 for quick access and a switch SW14 for turning on or off the power supply are provided.

Further, in FIG. 2, the processor 34 includes a CPU (not shown) in the inside, and the respective parts of the imaging apparatus 1 are controlled by the processor 34. On the outside of the processor 34, the SDRAM 33, the RAM 35, the ROM 37, and the built-in memory 36 are provided, and are connected with the processor 34 via bus lines. In the ROM 37, various control programs, for causing the CPU to carry out various functions, and parameters are stored. In the built-in memory 36, image data of photographed images are stored.

In the SDRAM 33, RAW-RGB image data (on which white balance correction and γ correction have been carried out), YUV image data (having been converted into brightness data and color difference data) and JPEG image data (having been compressed according to JPEG) are stored. The RAW-RGB image data, the YUV image data and the JPEG image data are obtained from conversion of the image data of the photographed images.

When the SW 14 for turning on or off the power supply is turned on by the user, the control programs stored in the ROM 37 are loaded into a memory (not shown) of the processor 34, and are executed by the CPU of the processor 34. Thus, the respective parts of the imaging apparatus 1 are controlled according to the control programs.

When the control programs are thus executed, the RAM 35 is used as a working area. Thus, on the RAM 35, control data and/or parameters are written, and the written data/parameters are read therefrom at anytime. All of the processes/operations described later according to the embodiments of the present invention are carried out mainly by the processor 34 as a result of the CPU of the processor 34 executing the control programs.

In the lens barrel unit 18, the zoom lens 18-1a, the focus lens 18-2a, the aperture 18-3a and the mechanical shutter 18-4a are driven by the zoom motor 18-1b, the focus motor 18-2b, the aperture motor 18-3b and the mechanical shutter motor 18-4b, respectively. These motors 18-1b through 18-4b are driven by the motor driver 18-5. The motor driver 18-5 is controlled by the CPU block 34-4 of the processor 34.

According to the embodiments of the present invention, the switch SW3 for wide-angle zooming (WIDE) and/or the switch SW4 for telephoto zooming (TELE) are operated by the user and an image of a subject is formed on the light reception part of the CCD 31 through the respective optical systems 18-1 and 18-2 of the lens barrel unit 18. The formed subject (image) is converted into an image signal by the CCD 31, and the image signal is output to the F/E-IC 32.

In the F/E-IC 32, the CDS 32-1 carries out correlation double sampling on the obtained image signal. The AGC 32-2 automatically carries out adjustment of the gain of the image signal obtained from the CDS 32-1. The A-D converter 32-3 converts the analog image signal obtained from the AGC 32-2 into a digital image signal. That is, the F/E-IC 32 carries out predetermined processes such as the noise reduction process, the gain adjustment process and so forth on the analog image signal output from the CCD 31, converts the analog image signal into the digital image signal, and outputs the digital image signal to the CCD1 signal processing block 34-2 of, the processor 34.

The TG 32-4 carries out a timing process such as a process of controlling timing of sampling of the image signal carried out by the F/E-IC 32, based on the VD and HD signals, transmitted in a feedback manner from the CCD1 signal processing block 34-2 of the processor 34.

The CPU block 34-4 of the processor 34 is connected with the F/E-IC 32, the motor driver 18-5, the sound recording circuit 38-1, the sound reproduction circuit 39-1 and the strobe circuit 40 causing the strobe light emitting part 13 to emit light, the distance measuring unit 15 and the sub-CPU 42. Therefore, these respective parts are controlled by the CPU block 34-4.

The sound input unit 38 and the sound reproduction unit 39 will now be described. A sound signal taken via the microphone 38-3 is amplified by the microphone amplifier 38-2, converted into a digital signal by the sound recording circuit 38-1, and recorded on the built-in memory 36, the memory card 52 or such, for example, according to control instructions given by the CPU block 34-4. The sound reproduction circuit 39-1 converts sound data previously recorded on the RAM 35 or such into a sound signal, the audio amplifier 39-2 amplifies the sound signal, and the speaker 39-3 outputs the corresponding sound, based on control instructions given by the CPU block 34-4.

The distance measuring unit 15 has a two-dimensional sensor, for example, as a distance measuring sensor, for example, and measures the distance to a subject included in a photographing area of the imaging apparatus 1, using the two-dimensional sensor. According to the embodiments of the present invention, as described above, even using such a two-dimensional sensor, it is possible to prevent a situation in which focusing on the subject becomes impossible by the subject being outside the distance-measurement-available-area of the distance measuring sensor which causes the distance measurement to be unavailable, by using contrast AF together with the two-dimensional sensor. The specific contents thereof according to the respective embodiments of the present invention will be described later.

To the sub-CPU 42, the sub-LCD 11 via the LCD driver 48, the AF LED 19, the strobe LED 20, the remote control light reception part 16, the operation key unit 43 including the above-mentioned switches SW1 through SW14, the buzzer 44 and so forth are connected. Therefore, these respective parts are controlled by the sub-CPU 42. Further, the sub-CPU 42 carries out monitoring of a state of a signal input to the remote control light reception part 16, a state of instructions input through the operation key unit 43 (for example, the above-mentioned switches SW1 through SW14, and so forth).

The USB block 34-6 of the processor 34 is connected with the USB connector 45, for example. The serial block 34-1 of the processor 34 is connected with the RS-232C connector 47 via the serial driver circuit 46, for example. Therefore, in the imaging apparatus 1 according to any one of the embodiments of the present invention, data communication may be carried out with an external apparatus (not shown) connected to the imaging apparatus 1 using the USB block 34-6 or the serial block 34-1.

The TV signal display block 34-10 of the processor 34 is connected with the LCD driver 48 for driving the LCD monitor 21, and a video amplifier 49 for amplifying a video signal and carrying out impedance matching. To the LCD driver 48, the LCD monitor 21 is connected, and, to the video amplifier 49, the video jack 50 for connecting with an external monitor apparatus such as a TV is connected. That is, the TV signal display block 34-10 converts the image data into the video signal, and outputs the video signal to the display part such as the LCD monitor 21 or the external monitor apparatus connected with the video jack 50.

The LCD monitor 21 is used to monitor a subject that is being photographed, display a photographed image, display an image recorded on the memory card 52 or the built-in memory 36, or so. It is noted that the LCD monitor 21 may have an input and/or output function using a touch panel or such, and in this case, it is possible to designate a certain subject or input various instructions based on a touch input operation carried out by the user via the touch panel or such.

To the memory card controller block 34-11, the memory card slot 51 is connected. Therefore, the imaging apparatus 1 transmits and receives the image data to and from the memory card 52 that is used for the purpose of extension.

It is noted that in the above-described configuration of the imaging apparatus 1, the lens barrel unit 18, the CCD 31, the F/E-IC 32 and the CCD1 signal processing block 34-2 act as an imaging part. Further, in the configuration shown in FIG. 2, the CCD 31 is used as a solid-state image sensor for carrying out photoelectric conversion of an optical image of a subject. However, it is not necessary to be limited thereto, and instead, for example, a complementary metal oxide semiconductor (CMOS) may be used for the same purpose. In this case, the CCD1 signal processing block 34-2 and the CCD2 signal processing unit 34-3 are replaced by a CMOS1 signal processing block and a CMOS2 signal processing unit, respectively, and similar processing is also carried out thereby.

### <Example of Functional Configuration of CPU Block 34-4>

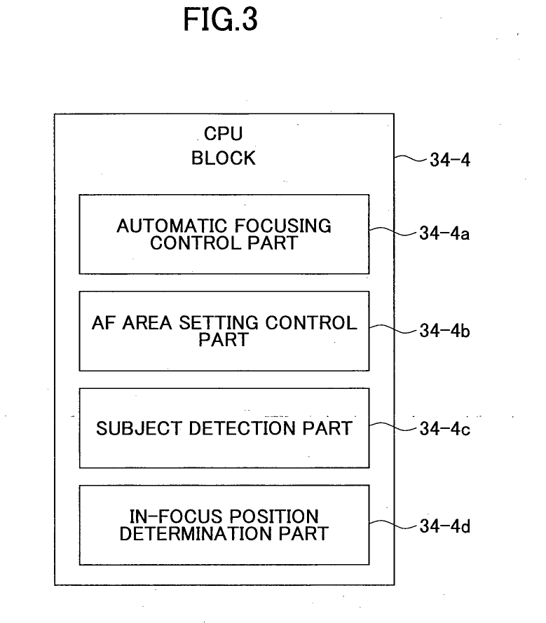

Next, a specific example of a functional configuration of the CPU block 34-4 according to the embodiments of the present invention will be described using figures. FIG. 3 shows one example of a functional configuration of the CPU block 34-4. The CPU block 34-4 shown in FIG. 3 includes an automatic focusing control part 34-4a, an AF area setting control part 34-4b, a subject detection part 34-4c and an in-focus position determination part 34-4d.

The automatic focusing control part 34-4a drives the optical system (for example, the lens barrel unit 18) included in the imaging part, for example, inputs an image of a subject to the light reception part of the image sensor (CCD 31), obtains an AF evaluation value based on the image signal obtained from the image sensor and carries out focusing control. It is noted that the subject means a subject detected in the subject detection part 34-4c, or such, for example. It is noted that the AF evaluation value is obtained by using, for example, a predetermined frequency component of the brightness data obtained from the digital RGB signal (see Patent Document 2, for example).

Further, the automatic focusing control part 34-4a carries out focusing control using a tracking AF function or such in a case where the subject is outside the distance-measurement-available-area of a distance measuring part, for example. The distance measuring part means a distance measuring system using plural two-dimensional sensors, for example. In the imaging apparatus 1 described above, the distance measuring unit 15 acts as the distance measuring part.

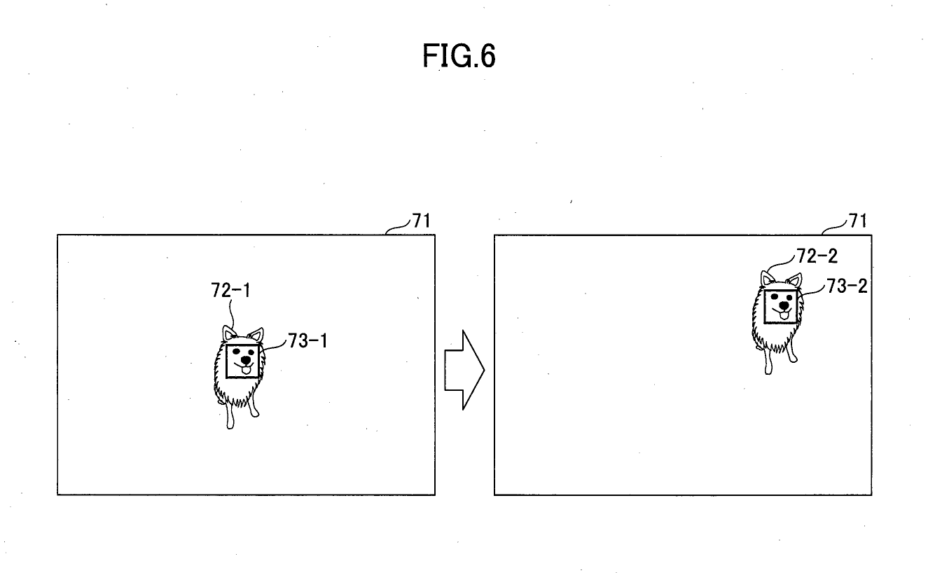

The AF area setting control part 34-4b sets an area (narrow-area AF area 73-1 or 73-2, for example, see FIG. 6) or the like, for which AF is to be further carried out, with respect to the entirety of the photographing area, based on a predetermined condition, at a time of carrying out AF.

The subject detection part 34-4c detects a certain subject from among one or plural subjects included in the photographing area of the imaging apparatus 1. For example, the subject detection part 34-4c detects the subject nearest to the imaging apparatus 1, or the subject which the user designates using the touch panel or such from the LCD monitor 21, for example.

Further, the subject detection part 34-4c carries out detection of a subject using the tracking AF function or such, based on a predetermined condition, for the purpose of avoiding a situation of it being impossible to measure the distance to the subject, in a case where the subject moves outside the photographing area because of the subject operation, the imaging apparatus 1 moving or such.

The in-focus position determination part 34-4d determines an in-focus position for the subject detected by the subject detection part 34-4c. It is noted that the specific processing contents to be carried out by the CPU block 34-4 will be described later.

### <Example of General Operations of Imaging Apparatus 1 According Embodiments>

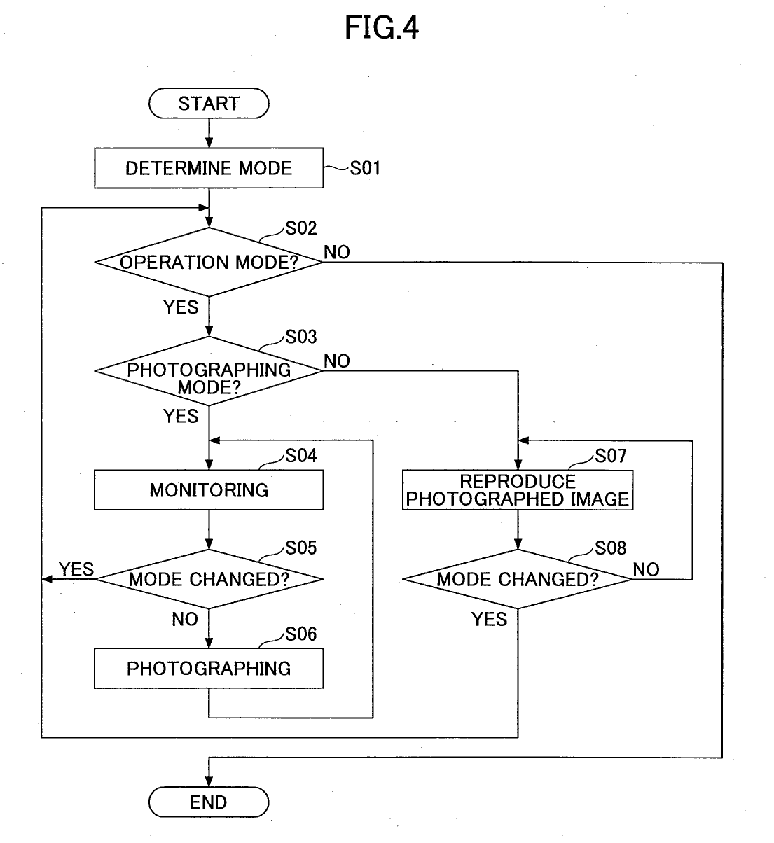

Next, an example of general operations of the imaging apparatus 1 will be described using a flowchart. FIG. 4 is a flowchart showing one example of an operation procedure of the imaging apparatus 1.

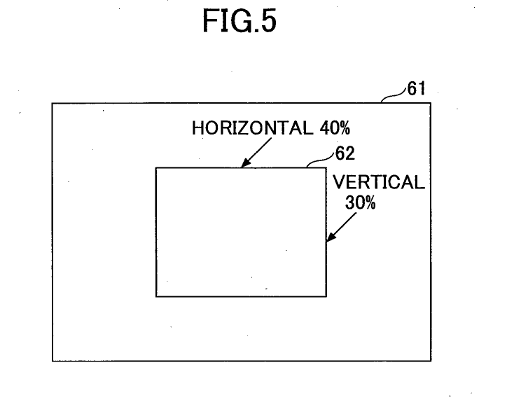

It is noted that in the operation procedure shown below, an operation mode of the imaging apparatus 1 includes a photographing mode (used at a time of photographing) and a reproduction mode (used at a time of reproducing a photographed image). Further, in the photographing mode, a face recognition mode and an ordinary mode are included. In the face recognition mode, the face of a subject is recognized, and an automatic exposure (AE) process, an automatic focusing (AF) process and so forth, are carried out on an image area including in and around the recognized face (referred to as a “face area”, hereinafter). In the ordinary mode, the AE process, the AF process and so forth, are carried out on an ordinary image area (referred to as an “ordinary area” (or “ordinary AF area” 62, see FIG. 5, for example), hereinafter). Further, in the photographing mode, a self-timer mode using the self-timer, a remote control mode of remotely controlling the imaging apparatus 1 by remote control, and so forth, are included.

It is noted that in the operation procedure according to the embodiments of the present invention, when the photographing mode is set using the switch SW2 of the mode dial in a state where the power switch SW14 of the imaging apparatus 1 is turned on, the imaging apparatus 1 enters the photographing mode. When the reproduction mode is set using the switch SW2 of the mode dial in a state where the power supply switch SW14 of the imaging apparatus 1 is turned on, the imaging apparatus 1 enters the reproduction mode. Therefore, when the power switch SW14 of the imaging apparatus 1 is turned on, the operation procedure shown in the flowchart of FIG. 4 is started.

In the operation procedure shown in FIG. 4, first, the mode having been set by the user is determined (step S01), and thus, it is determined whether the set mode is one included in the operation mode (step S02). In a case where the set mode is one included in the operation mode (step S02 YES), then it is determined whether the set mode is the photographing mode (step S03). That is, in steps S01, S02 and S03, it is determined whether the state of the switch SW2 of the mode dial is the photographing mode, the reproduction mode or another mode.

In step S03, when the state of the switch SW2 corresponds to the photographing mode (step S03 YES), a monitoring process is carried out (step S04). In step S04, the processor 34 controls the motor driver 18-5, a lens barrel included in the lens barrel unit 18 is moved to a position of being able to carry out photographing, and further, power is supplied to respective circuits required for photographing, i.e., for example, the CCD 31, F/E-IC 32, LCD monitor 21 and so forth. Then, information of an image of a subject thus formed on the light reception part of the CCD 31 by the respective optical systems (zoom optical unit 18-1 and focus optical unit 18-2) is converted into the RGB analog signal by the CCD 31 at any time. Then, the predetermined processes such as the above-mentioned noise reduction process, the gain adjustment process and so forth are carried out on the RGB analog signal by the CDS circuit 32-1 and the AGC 32-2, converted into the RGB digital signal by the A-D converter 32-3, and output to the CCD1 signal processing block 34-2 of the processor 34.

Further, the RGB digital signal is converted into the RAW-RGB image data, the YUV image data and the JPEG image data by the CCD1 signal processing block 34-2, and is written on a frame memory of the SDRAM 33. It is noted that among these sorts of image data, the YUV image data is read out from the frame memory at any time, is converted into the video signal by the TV signal display block 34-10, and is output to the LCD monitor 21 or the external monitor apparatus such as a TV.

Thus, a process, in which the image data of the subject is taken into the frame memory of the SDRAM 33 and the image of the subject is output to the LCD monitor 21 or the external monitor apparatus such as the TV during a photographing waiting state, is referred to as the “monitoring process” (step S04).

After the monitoring process of step S04 is thus carried out, it is determined whether the setting has been changed by, for example, the switch SW2 of the mode dial (step S05). When the setting has been changed (step S05 YES), the flow proceeds to step S02, and the subsequent processes according to the thus changed setting are carried out. When the setting has not been changed (step S05 NO), a photographing process (step S06) is carried out.

In step S06, the state of the release switch SW1 is determined. When the release switch SW1 has not been pressed by the user, the flow then returns to step S04. When the release switch SW1 has been pressed, a process, in which the image data of the subject taken into the frame memory of the SDRAM 33 at this time is recorded on the built-in memory 36 or the memory card 52, and so forth, is carried out. After that, the flow returns to step S04.

That is, in a case where the imaging apparatus 1 operates in the photographing mode, steps S04 through S06 are repeated. The state of repeating is referred to as a “finder mode”. In the imaging apparatus 1 according to the embodiments of the present invention, these steps are repeated at a period of approximately 1/30 seconds, and along with the repeating operations, the display indicated on the LCD monitor 21 or the external monitor apparatus is updated.

Further, in step S03, when the operation mode is not the photographing mode (step S03 NO), the imaging apparatus 1 enters the reproduction mode, and reproduces a photographed image (step S07). In step S07, the image data recorded on the built-in memory 36, the memory card 52 or such, is output to the LCD monitor 21 or the external monitor apparatus such as the TV.

Then, it is determined whether the setting has been changed from the switch SW2 of the mode dial (step S08). When the setting has been changed (step S08 YES), the flow returns to step S02, and the subsequent processes are carried out. When the setting has not been changed (step S08 NO), the flow returns to step S07, and step S07 is carried out again.

Next, as main functions of the imaging apparatus 1 according to the embodiments, the AE function, the AF function, the tracking AF function, the distance measuring function using the distance measuring sensor of the distance measuring unit 15 will be described in detail.

### <AE Function>

The automatic exposure (AE) function in the imaging apparatus 1 is a function of automatically determining an exposure amount in the light reception part of the image sensor (i.e., the CCD 31 in the embodiments) by changing a combination of an aperture value and a shutter speed in an imaging apparatus such as a camera (i.e., the imaging apparatus 1 in the embodiments).

### <AF Function>

Next, the AF function of the imaging apparatus 1 will be described. The automatic focusing (AF) function is a function of automatically adjusting the focus of the photographing lenses (camera lenses). When an image taken by the CCD 31 is in an in-focus state, the contour part of the image of the subject is clear, and thus, an AF evaluation value at the contour part of the image increases.

At a time of focus detection in “contrast AF” control, while the focus lens 18-2a is moved in an optical axis direction, the AF evaluation values at respective movement positions of the focus lens 18-2a are calculated, and the position of the focus lens 18-2a at which the AF evaluation value has a maximum value is detected.

Further, in a case where there are plural positions at each of which the AF evaluation value becomes maximum, the most reliable position thereamong is determined considering the magnitudes of the AF evaluation values and the rising degrees of the AF evaluation values and the falling degrees of the AF evaluation values around the maximum AF evaluation values, respectively. Then, the thus determined position is used as the in-focus position in the AF process. In a case where any one of the plural positions at each of which the AF evaluation value becomes maximum are highly reliable, the maximum position of the shortest distance is determined as the in-focus position.

The data of the AF evaluation values are recorded at any time in the memory of the processor 34 as characteristic data of the image data, and the characteristic data is used for the AF process. The AF evaluation values may be calculated based on the digital RGB signal for a specific area of the taken image.

FIG. 5 shows one example of an AF area (ordinary AF area). It is noted that in FIG. 5, a display state of the LCD monitor 21 in the finder mode is shown, and a central frame in a LCD display area 61 is an ordinary AF area 62 as the above-mentioned specific area of the taken image in the imaging apparatus 1. In the example shown in FIG. 5, the ordinary AF area 62 is an area having a horizontal length of 40% and a vertical length of 30% with respect to the LCD display area 61. However, the size of the ordinary AF area 62 is not limited thereto.

In the imaging apparatus 1 according to the embodiments of the present invention, when the release switch SW1 is pressed, an AE evaluation value indicating the exposure state and the AF evaluation value indicating the degree of focusing on the screen are calculated based on the RGB digital signal taken in the CCD1 signal processing block 34-2 of the processor 34.

### <Tracking AF Function>

Next, the tracking AF function of the imaging apparatus 1 will be described using the figure. FIG. 6 illustrates one example of AF areas (i.e., narrow-area AF areas 73-1 or 73-2) at a time of tracking AF. The tracking AF function is a function of searching an entire photographing area (image) 71 taken by the image sensor for a subject pattern-registered as a target to track and continuing to focus on the position of the thus detected subject pattern, so that even when the subject moves about in the entire photographing area 71, the subject can be brought into focus when the subject is being photographed.

In order to detect the subject which is the target to track (hereinafter referred as a “tracking subject”) 72-1 from the photographing area 71, template matching is used in many cases. More specifically, comparison is carried out between a template stored in the ROM 37 and an image taken by the image sensor such as the CCD 31, and in a case where an image or characteristics similar to the template has been detected in the taken image, it is determined that the tracking subject has been detected. Further, the template is image data itself, characteristics such as a histogram obtained from image data, or such, for example.

According to the embodiments of the present invention, a histogram of a tracking subject designated by the user is used as a template. Further, according to the embodiments of the present invention, as a method of continuing to focus on the detected tracking subject 72-1, a method of repeating narrow-area AF used, for example. Specifically, in a case where it has been determined that the tracking subject has moved on the screen (according to the embodiments, it has been determined that the tracking subject has moved in a case where the position of the tracking subject has moved on the entire photographing area 71), an area on which AF will be carried out is moved to a position to which the tracking subject has thus moved on the screen. It is noted that to determine as to whether the tracking subject has moved on the screen, and to move on the screen the position of an area on which AF will be carried out to a position to which the tracking subject has thus moved are carried out based on, for example, the above-mentioned template matching. Then, at the position, AF for a much narrower area (i.e., the narrow-area AF area 73-1 or 73-2, in FIG. 6) than the ordinary AF area (i.e., the ordinary AF area 62) is carried out around the current focal position. Then, in a case where an in-focus position has been found, the narrow-area AF is finished. In a case where no in-focus position has been found, it is determined whether an in-focus position may exist at a short distance or long distance along the optical axis directions, based on the rising and falling degrees of the AF evaluation values having been obtained in the past AF process. Then, the focus of the camera lenses is moved in the optical axis direction in which the in-focus position is expected to exist, and then, narrow-area AF is carried out again. This process is carried out until an in-focus position is found, and thereby, the tracking subject 72-1 is continued to be focused.

The tracking AF mode can be selected by the menu switch SW6 of the imaging apparatus 1. Alternatively, the tracking AF mode may be easily selected as a result of an operation mode being previously registered at the quick access switch SW8, and the switch SW8 being operated.

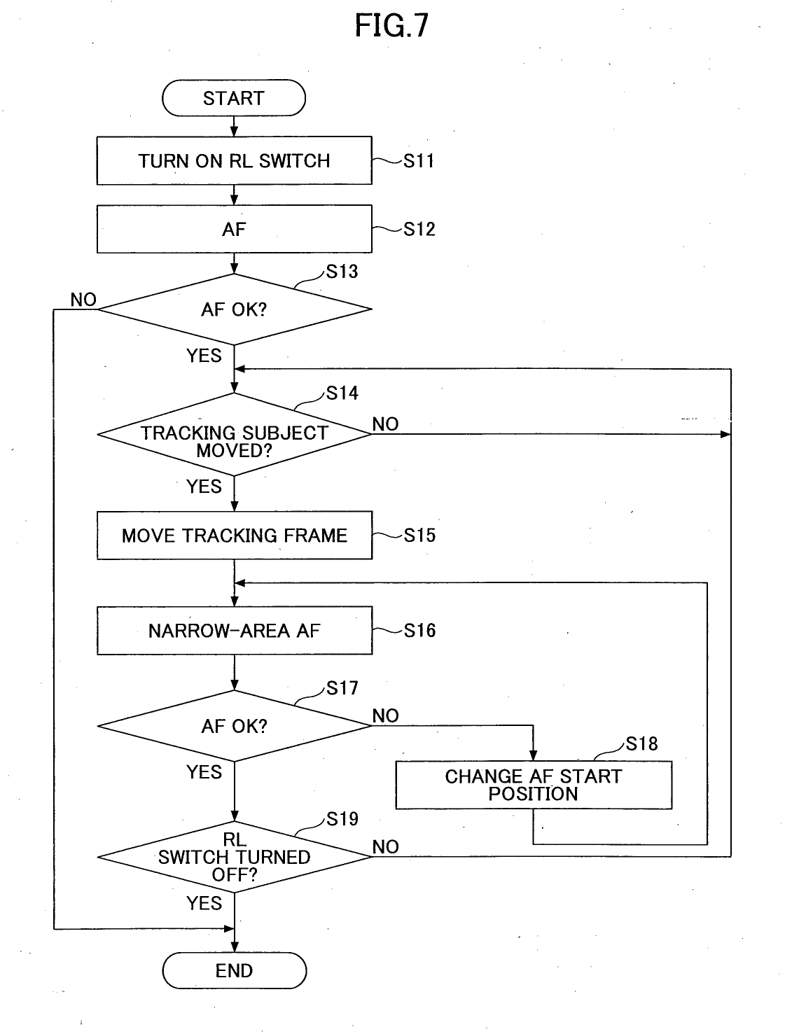

Next, using a flowchart, a specific process of the tracking AF will be described. FIG. 7 is a flowchart showing one example of the tracking AF procedure. In the tracking AF mode, when a tracking AF start instruction is input by the user, the tracking AF process is started (step S11) (in FIG. 7, indicated as “turn on RL switch” for the sake of convenience). Specifically, when the release switch (which may be referred to as a “RL switch”) SW1 is half pressed by the user, the tracking AF start instruction is input, and the tracking AF is started. While the release switch SW1 is half pressed continuously, the tracking AF is carried out continuously.

When the release switch SW1 is half pressed, a subject, existing in an area (i.e., the narrow-area AF area 73-1 in FIG. 6) having a length of 10% in the horizontal direction and a length of 10% in the vertical direction, for example, at the center of the monitor screen, is registered as a tracking target (or a tracking subject 72-1), and AF is carried out on the narrow-area AF area 73-1 (step S12).

Then, it is determined whether the AF has succeeded (step S13). It is noted that “the AF has succeeded” (or “the AF result is successful”) means that the in-focus position of the tracking subject has been found based on the AF evaluation values as described above. The same manner will be applied also hereinafter. In a case where the AF has succeeded (step S13 YES), the tracking AF is started. Specifically, the tracking subject 72-1 (see FIG. 6) is always searched for from the screen (according to template matching, for example) continuously, and thus, the position of the tracking subject 72-1 on the screen is updated accordingly. That is, it is determined whether the position of the tracking subject 72-1 has moved on the screen (step S14). In a case where the position has moved on the screen (step S14 YES), a frame of the narrow-area AF area 73-1 (i.e., the AF frame or a tracking frame) displayed on the screen of the display part, i.e., the LCD monitor 21 in the embodiments, is moved on the screen to a position (of the narrow-area AF area 73-2, see FIG. 6) the same as or similar to a position at which the tracking subject has thus moved (step S15). It is noted that the above-mentioned searching for the tracking subject on the screen is carried out based on, for example, the above-mentioned template matching. Further, since the position of the tracking subject 72 has thus moved from the previous position on the screen, narrow-area AF is carried out at the updated position on the screen, and thus, the in-focus position of the tracking subject 72-1 is searched for along the optical axis directions (step S16).

Then, it is determined whether the AF result in step S16 is successful (step S17). In a case where the AF result is not successful (step S17 NO), the AF start position is moved in the optical axis direction in which the in-focus position is expected to exist, for example (step S18), flow proceeds to step S16, and AF is carried out again.

Then, it is determined whether half pressing of the RL switch SW1 has been broken (step S19) (in FIG. 7, “RL switch turned off?”, for the sake of convenience). It is noted that determination as to whether half pressing of the RL switch SW1 has been broken is carried out as follows. That is, in a case where the finger of the user has been removed from the RL switch SW1 or has pressed the switch SW1 completely, it is determined that half pressing of the RL switch SW1 has been broken. In a case where the half pressing of the switch SW1 has not been broken (step S19 NO), the flow returns to step S14. In a case where the half pressing of the switch SW1 has been broken (step S19 YES), or in a case where the AF result is not successful (step S13 NO), the flow is then finished. In a case where the tracking subject 72-1 has not moved on the screen (step S14 NO), step S14 is carried out again.

### <Distance Measuring Function Using Distance Measuring Sensor of Distance Measuring Unit 15>

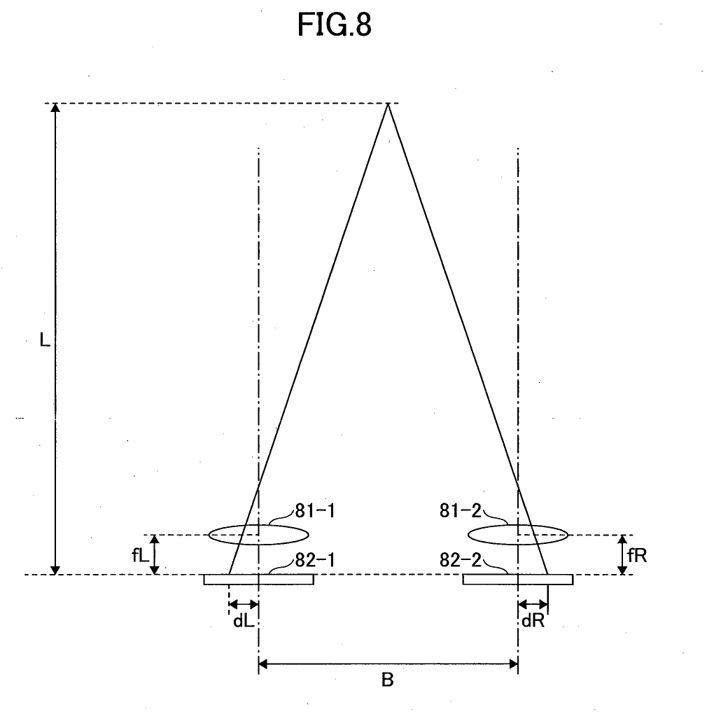

Next, the distance measuring function using the distance measuring sensor of the distance measuring unit 15 will be described using FIG. 8. FIG. 8 illustrates one example of a distance measuring method. The distance measuring sensor according to the embodiments of the present invention is, for example, a sensor in which a first set of a lens 81-1 and an image sensor (two-dimensional sensor) 82-1 and a second set of a lens 81-2 and an image sensor (two-dimensional sensor) 82-2 are arranged, and a distance to a subject is measured according to triangulation using parallax between images obtained from the two image sensors 82-1 and 82-2. It is noted that distance measuring may be carried out at all the positions included in the entire photographing area (image).

In the example of FIG. 8, B denotes the length of a base line which is a space between the lenses 81-1 and 81-2. fL and fR denote focal lengths of the respective lenses 81-1 and 81-2. It is supposed that fL and fR have a relationship of fL=m×fR. That is, “m” denotes a ratio of the focal lengths.

As shown in FIG. 8, an image of a subject for which a distance is to be measured is formed on the image sensors 82-1 and 82-2 at positions of dL and dR based on the length B of the base line. At this time, the length L (the distance to the subject) is obtained from the following formula (1):

L={(B+dL+dR)×m×fR}/(dL+m×dR) (1)

It is noted that in a case where an optical system only for the purpose of distance measuring is prepared in addition to the main lenses (camera lenses), fR may be equal to fL, and fR and fL may be equal to f, and the formula (2) may be used instead of the formula (1):

L={(B+dL+dR)×f}/(dL+dR) (2)

In the formula (1), the focal lengths of the left and right lenses 81-1 and 82-2 may be different therebetween, and thus, the main lenses (camera lenses) for photographing may be used as the lens 82-1, for example. Thus, it is possible to obtain the distance L by measuring dL and dR based on the length B of the base line. It is noted that according to the embodiments of the present invention, distance measuring may be always carried out at predetermined timings according to the above-mentioned distance measuring method, and the distance measuring result may be always updated continuously when the photographing mode is maintained in the imaging apparatus 1. It is noted that the number of the two-dimensional sensors is not limited to 2, and for example, equal to or greater than 3 plural two-dimensional sensors may be used.

Next, the tracking AF procedure using the distance measuring sensor according to the embodiments of the present invention will be described in detail. It is noted that the tracking AF procedure described now is carried out, for example, by the respective parts of the CPU block 34-4 described above using FIG. 3.

### Tracking AF Procedure

### Embodiment 1

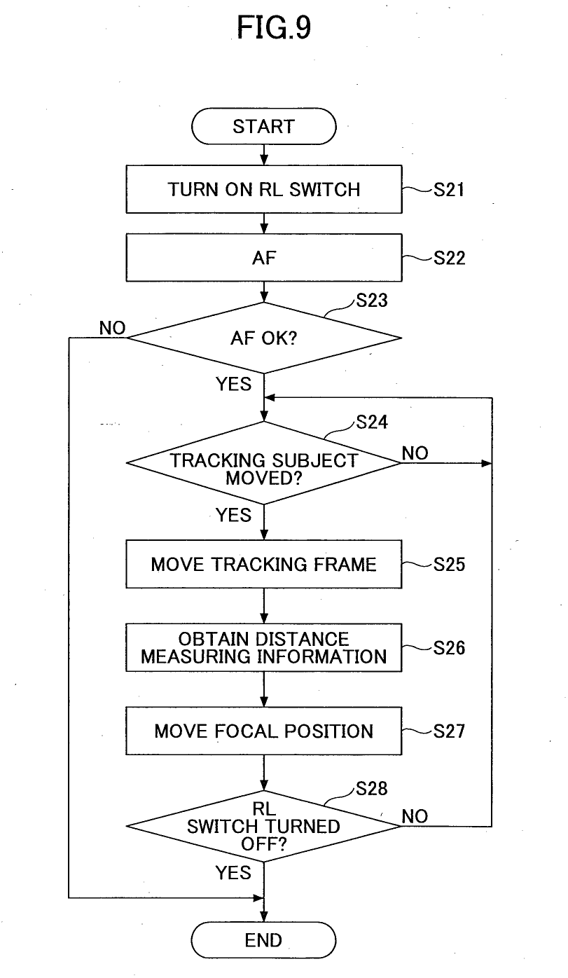

FIG. 9 is a flowchart showing one example of the tracking AF procedure according to the embodiment 1 of the present invention.

As described above, in a case where tracking AF is carried out, usually, focusing on an area of a tracking subject is continuously carried out. As a specific method therefor, there are a method of continuing to carry out focusing while moving a position to carry out focusing on the screen until an in-focus position of the tracking subject is found, a method of finding an in-focus position of the tracking subject by repeating a search a narrow area (narrow-area AF area) while moving the narrow-AF area on the screen as described above for the tracking AF, and so forth.

However, in any method, it may be difficult to cope with a sharp change in distance to the subject. For example, in the method of repeating a search a narrow-area AF area while moving the narrow-AF area on the screen, it is necessary to repeat narrow-area AF many times to search for an in-focus position of the tracking subject. Therefore, according to the embodiment 1, tracking AF which is robust against a sharp change in distance to the subject is realized by using the distance measuring sensor.

Specifically, as shown in FIG. 9, first, as a result of the RL switch SW1 being half pressed (step S21) (in FIG. 9, “turn on RL switch” for the sake of convenience), AF is carried out on a central area (the narrow-area AF area) of the screen (step S22). Then, after the focusing operation is carried out, it is determined whether the AF result is successful (step S23).

In a case where the AF result is successful (step S23 YES), the subject in the narrow-area AF area is registered as a tracking target, and tracking AF for the tracking target is started. After the starting of tracking AF, it is determined whether the tracking subject has moved (step S24). In a case where the tracking subject has moved (step S24 YES), the flow proceeds to a process of moving the tracking frame (or AF frame) for and focusing on the tracking subject which has thus moved.

Specifically, first, the tracking frame (or AF frame) is moved to the position where the tracking target has moved (step S25). After that, according to the related art, the tracking subject may be continuously focused by simply carrying out AF for a minute area (narrow-area AF area) in a case where the tracking target has moved. In contrast thereto, according to the embodiment 1 of the present invention, in a case where the tracking target has moved, instead of carrying out AF to focus on the tracking target, a distance measuring result is obtained corresponding to the area of the tracking target (step S26), and the tracking subject is focused as a result of moving the focus of the camera lenses to the position of the distance measuring result (step S27).

Then, it is determined whether half pressing of the RL switch SW1 has been broken (step S28) (in FIG. 9, “RL switch turned off?”, for the sake of convenience). It is noted that determination as to whether half pressing of the RL switch SW1 has been broken is carried out as follows. That is, in a case where the finger of the user has been removed from the RL switch SW1 or has pressed the switch SW1 completely, it is determined that half pressing of the RL switch SW1 has been broken. In a case where the half pressing of the switch SW1 has not been broken (step S28 NO), the flow returns to step S24. In a case where the half pressing of the switch SW1 has been broken (step S28 YES), or in a case where the AF result is not successful (step S23 NO), the flow is then finished. In a case where the tracking subject 72-1 has not moved on the screen (step S24 NO), step S24 is carried out again.

According to the embodiment 1, by carrying out the above-described process, it is possible to immediately focus on the tracking target even for cases of various changes of the distance to the tracking target. Thereby, it is possible to solve the problem of not being able to immediately focus on the tracking target due to a sharp change in distance to the subject at a time of tracking AF.

### Tracking AF Procedure

### Embodiment 2

Next, the tracking AF procedure according to the embodiment 2 of the present invention will be described using a flowchart. According to the embodiment 2, tracking AF is carried out using, for example, a result of the distance measuring sensor, and also narrow-area AF. In a case of carrying out tracking AF according to the method of the embodiment 1 described above, the accuracy of the result of the distance measuring sensor may have an influence on the process of tracking AF. Specifically, according to the embodiment 1, the focus is moved to the position of the distance measuring result. Therefore, if the distance measuring result has an error, the focus of the camera lenses may be moved to the position at which the tracking subject is not in focus. Therefore, according to the embodiment 2, narrow-area AF is carried out in the vicinity of the distance measuring result along the optical axis directions so that it is possible to accurately focus on the tracking subject even if somewhat error is included in the distance measuring result.

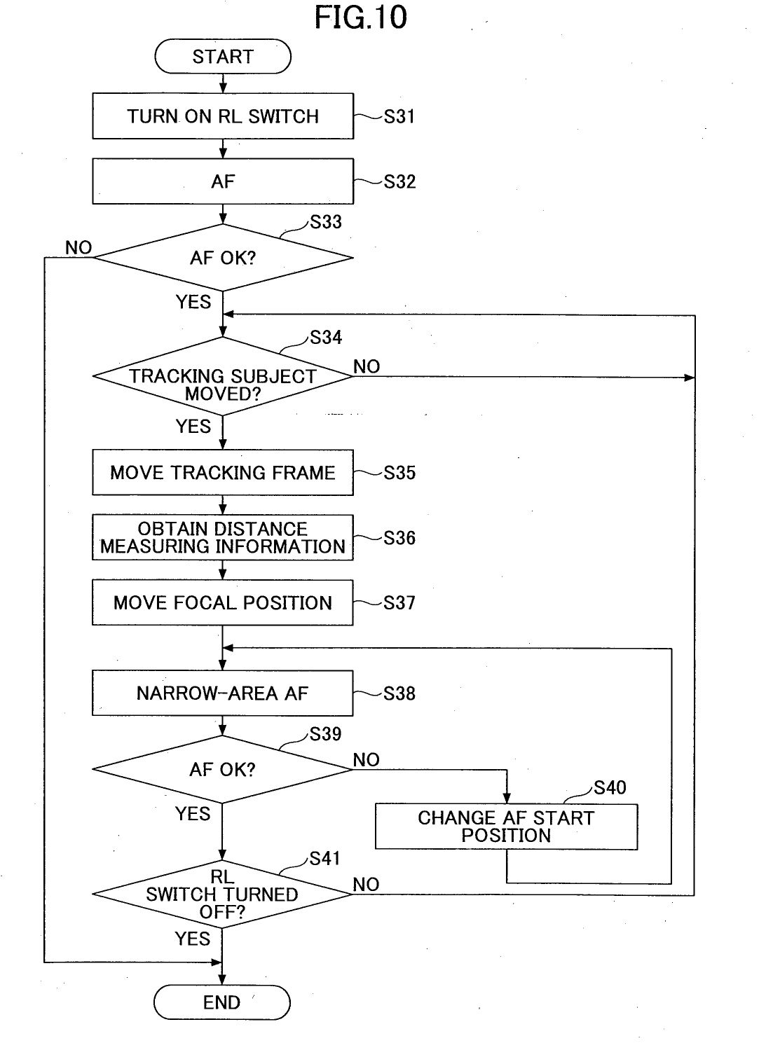

The process of narrow-area AF using a distance measuring result according to the embodiment 2 will be described now using a flowchart. FIG. 10 is a flowchart of one example of the tracking AF procedure according to the embodiment 2. According to the embodiment 2, tracking AF is started as in the embodiment 1, and when a tracking subject has moved, the narrow-area AF area is moved accordingly, and positional information (distance measuring result) of the tracking subject is obtained from the distance measuring sensor at the thus moved narrow-area AF area. After that, a narrow AF scanning range along the optical axis directions is set using the thus obtained distance measuring result as a center of the AF scanning range, and thus, narrow-area AF is carried out at the thus moved narrow-area AF area. Thereby, it is possible to find the in-focus position of the tracking subject within the small number of times of AF even when a sharp change in distance to the subject occurs.

Specifically, as shown in FIG. 10, first, as a result of the RL switch SW1 being half pressed (step S31) (in FIG. 10, “turn on RL switch” for the sake of convenience), AF is carried out on a central area (the narrow-area AF area) of the screen (step S32). Then, after the focusing operation is carried out, it is determined whether the AF result is successful (step S33).

In a case where the AF result is successful (step S33 YES), the subject in the narrow-area AF area is registered as a tracking target, and tracking AF for the tracking target is started. After the starting of tracking AF, it is determined whether the tracking subject has moved (step S34). In a case where the tracking subject has moved (step S34 YES), the flow proceeds to a process of moving the tracking frame (or AF frame) for and focusing on the tracking subject which has moved.

Specifically, first, the tracking frame (or AF frame) is moved to the position where the tracking target has moved (step S35). After that, a distance measuring result is obtained corresponding to the area to which the tracking target has moved (step S36), and the focus of the camera lenses is moved to the position of the distance measuring result (step S37).

Next, narrow-area AF is carried out in the vicinity of the distance measuring result along the optical axis directions so that the tracking subject may be focused (step S38). Then, it is determined whether the result of AF carried out in step S38 is successful (step S39). In a case where the AF result is not successful (step S39 NO), the AF start position is moved in the optical axis direction in which the in-focus position is expected to exist, for example (step S40), flow proceeds to step S38, and narrow-area AF is carried out again.

In a case where the AF result is successful (step S39 YES), it is determined whether half pressing of the RL switch SW1 has been broken (step S41) (in FIG. 10, “RL switch turned off?”, for the sake of convenience). It is noted that determination as to whether half pressing of the RL switch SW1 has been broken is carried out as follows. That is, in a case where the finger of the user has been removed from the RL switch SW1 or has pressed the switch SW1 completely, it is determined that half pressing of the RL switch SW1 has been broken. In a case where the half pressing of the switch SW1 has not been broken (step S41 NO), the flow returns to step S34. In a case where the half pressing of the switch SW1 has been broken (step S41 YES), or in a case where the AF result is not successful (step S33 NO), the flow is then finished. In a case where the tracking subject has not moved on the screen (step S34 NO), step S34 is carried out again.

According to the embodiment 2, by carrying out the above described process, it is possible to focus on the tracking target in response to various changes of the distance to the tracking target without depending on an error, if any, in the distance measuring result. Thus, it is possible to eliminate the problem of the tracking target being not in focus in a case where the distance measuring result has an error.

### Tracking AF Procedure

### Embodiment 3

Next, the tracking AF procedure according to the embodiment 3 of the present invention will be described using a flowchart. According to the embodiment 3, it is determined, depending on the focal length in the camera lenses, whether to use a result of the distance measuring sensor at a time of tracking AF.

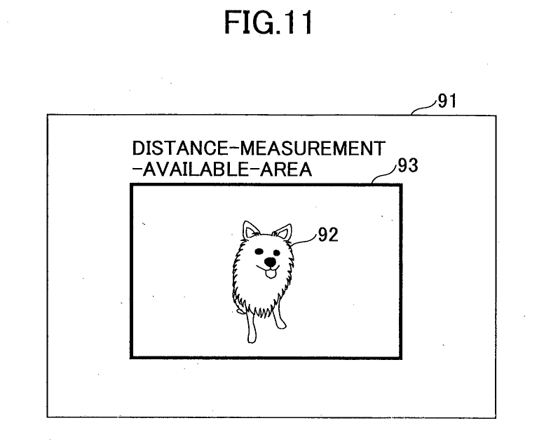

FIG. 11 shows one example of a distance-measurement-available-area in a WIDE mode. Recently, there are many cameras (imaging apparatuses) in which zooming is possible for a focal length corresponding to high magnification. In this case, since the focal length is very different between the WIDE mode and a TELE mode, the angle of view is much different therebetween accordingly. However, since the lenses in the distance measuring sensor are those in which zooming is not possible, the angle of view is fixed for the distance measuring sensor. Therefore, in order to carry out distance measuring for the entire area of the angle of view through the full range of the focal length between the WIDE end and the TELE end in the camera lenses, the focal length of the distance measuring sensor is to be set to be equal to the focal length at the WIDE end. However, in the case where the imaging apparatus 1 is the high-magnification camera, when the focal length of the distance measuring sensor is thus set to be equal to the focal length at the WIDE end, an area which can be seen from the screen of the distance measuring sensor when the camera lenses have the angle of view at the WIDE end corresponds to a very small area which can be seen from the screen of the distance measuring sensor when the camera lenses have the angle of view at the TELE end. Therefore, the distance measuring accuracy may be much degraded at the TELE end since the area which can be seen from the screen of the distance measuring sensor at the TELE end is thus very small.

Therefore, according to the embodiment 3, as shown in FIG. 11, a distance-measurement-available area 93 including a tracking subject 92 is set with respect to the entirety of the photographing area 91, and the distance measuring sensor is to be one having a focal length increased so that distance measuring can be carried out only within the distance-measurement-available-area 93 at the WIDE end. Thereby, it is possible to carry out distance measuring both in the WIDE mode and in the TELE mode.

It is noted that according to the embodiment 3, one example of the focal length of the distance measuring sensor is set to be approximately 80 mm. In this case, since the focal length of the distance measuring sensor is thus set as being increased so that distance measuring can be carried out only within the distance-measurement-available-area 93 at the WIDE end as mentioned above, it is thus not possible to carry out distance measuring for the entire area of the angle of view at the WIDE mode. Therefore, it is impossible to carry out tracking AF using a distance measuring result at the edge of the screen. Therefore, according to the embodiment 3, it is determined whether to use the result of distance measuring for tracking AF depending on the focal length of the camera lenses.

Specifically, in a case where the focal length of the camera lenses is less than the focal length of the distance measuring sensor (in the above-mentioned example, 80 mm), the result of distance measuring is not used. In a case where the focal length is thus short, a necessary moving amount of the focus in AF with respect to an actual change of the distance to the subject is smaller than a case where the focal length is long. Therefore, when AF is carried out using the same focus moving amount, the shorter the focal length of the camera lenses becomes, the longer the distance becomes for which search for the in-focus position can be carried out. Therefore, in a case where the focal length of the camera lenses is shorter, there is a small likelihood of losing the in-focus position for the tracking subject in tracking AF, even in a case where a sharp change in distance to the tracking subject occurs.

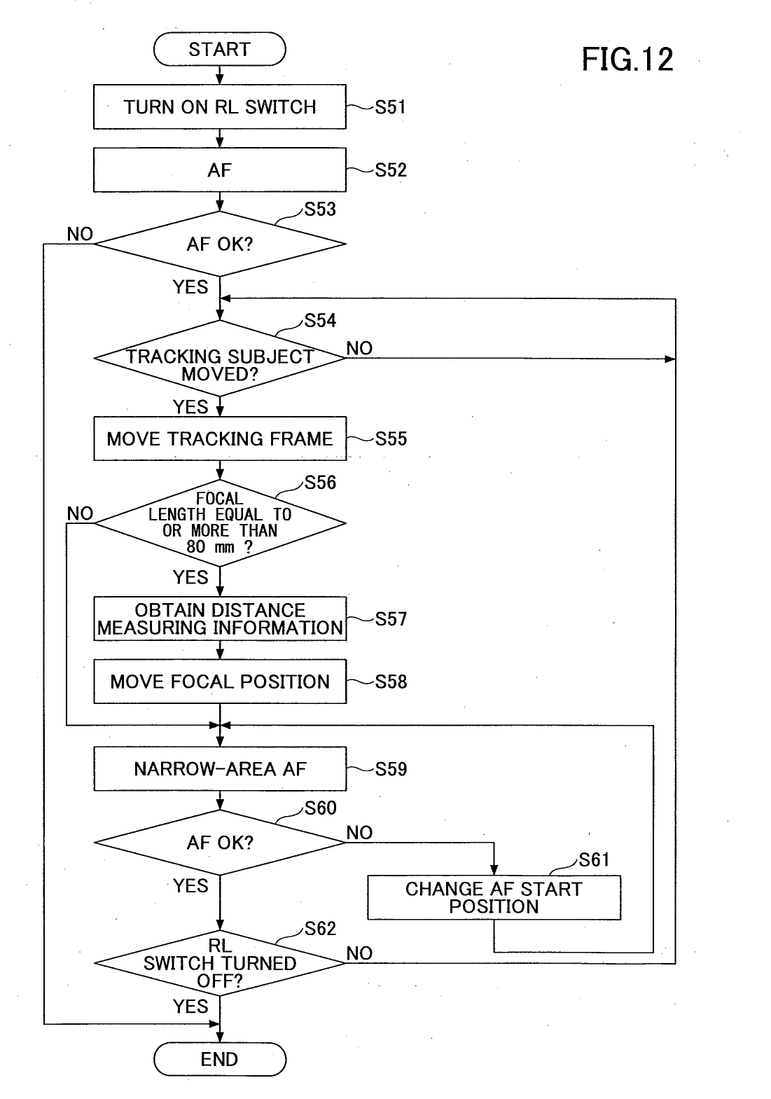

One example of the tracking AF procedure according to the embodiment 3 including a specific method of determining by using the focal length of the camera lenses whether to use the distance measuring sensor will now be described using a flowchart. FIG. 12 is a flowchart showing one example of the tracking AF procedure according to the embodiment 3.

Specifically, as shown in FIG. 12, first, as a result of the RL switch SW1 being half pressed (step S51) (in FIG. 12, “turn on RL switch” for the sake of convenience), AF is carried out on a central area (the narrow-area AF area) of the screen (step S52). Then, after the focusing operation is carried out, it is determined whether the AF result is successful (step S53).

In a case where the AF result is successful (step S53 YES), the subject in the narrow-area AF area is registered as a tracking target, and tracking AF for the tracking target is started. After the starting of tracking AF, it is determined whether the tracking subject has moved (step S54). In a case where the tracking subject has moved (step S54 YES), the flow proceeds to a process of moving the tracking frame (or AF frame) for and focusing on the tracking subject which has moved.

Specifically, first, the tracking frame (or AF frame) is moved to the position where the tracking target has moved (step S55). After that, focusing is carried out for the tracking target which has moved. At this time, the current focal length of the camera lenses is compared with the focal length of the distance measuring sensor. That is, it is determined whether the focal length of the camera lenses is equal to or greater than the focal length (in the above-mentioned example, 80 mm) of the distance measuring sensor (step S56). In a case where the focal length of the camera lenses is equal to or greater than the focal length of the distance measuring sensor (step S56 YES), AF using a distance measuring result of the distance measuring sensor is carried out. Specifically, a distance measuring result is obtained corresponding to the area of the tracking target which has moved (step S57), and the tracking subject is focused as a result of the focus of the camera lenses being moved to the position of the distance measuring result (step S58).

After the finish of step S58, narrow-area AF is carried out (step S59). In a case where the focal length of the camera lenses is less than the focal length (80 mm in the above-mentioned example) of the distance measuring sensor (step S56 NO), AF is carried out only using narrow-area AF without using a distance measuring result of the distance measuring sensor (step S59). In the case of the process of not using a distance measuring result of the distance measuring sensor, the distance measuring operation of the distance measuring sensor itself may be stopped or may be continued.

Next, it is determined whether the result of AF carried out in step S59 is successful (step S60). In a case where the AF result is not successful (step S60 NO), the AF start position is moved in the optical axis direction in which the in-focus position is expected to exist, for example (step S61), flow proceeds to step S59, and AF is carried out again.

In a case where the AF result is successful (step S60 YES), it is determined whether half pressing of the RL switch SW1 has been broken (step S62) (in FIG. 12, “RL switch turned off?”, for the sake of convenience). It is noted that determination as to whether half pressing of the RL switch SW1 has been broken is carried out as follows. That is, in a case where the finger of the user has been removed from the RL switch SW1 or has pressed the switch SW1 completely, it is determined that half pressing of the RL switch SW1 has been broken. In a case where the half pressing of the switch SW1 has not been broken (step S62 NO), the flow returns to step S54. In a case where the half pressing of the switch SW1 has been broken (step S62 YES), or in a case where the AF result is not successful (step S53 NO), the flow is then finished. In a case where the tracking subject has not moved on the screen (step S54 NO), step S54 is carried out again.

According to the embodiment 3, as a result of carrying out the above-described process, it is possible to carry out tracking AF using a distance measuring result even when using a camera having any focal length and using a distance measuring sensor having any focal length.

### Tracking AF Procedure

### Embodiment 4

Next, the tracking AF procedure according to the embodiment 4 of the present invention will be described using a flowchart. According to the embodiment 4, it is determined depending on the focal length of the camera lenses and the position of the tracking subject on the screen whether to use a distance measuring result of the distance measuring sensor at a time of tracking AF.

As also described above for the embodiment 3, there may be a case where it is not possible to carry out distance measuring for the entire area of the angle of, view at the WIDE end in a camera in which it is possible to carry out zooming to the focal length corresponding to high magnification. In this case, it is not possible to carry out distance measuring at a peripheral area (edge) of the screen. Therefore, according to the embodiment 4, instead of not using a distance measuring result as in the embodiment 3 in a case where the focal length of the camera lenses is one at which there is an area (peripheral area or edge) for which distance measuring is not possible, a distance measuring result is not used only in a case where a tracking subject has moved to an area (peripheral area or edge) for which distance measuring is not possible. Thereby, it is possible to increase the number of situations of being able to use distance measuring results.

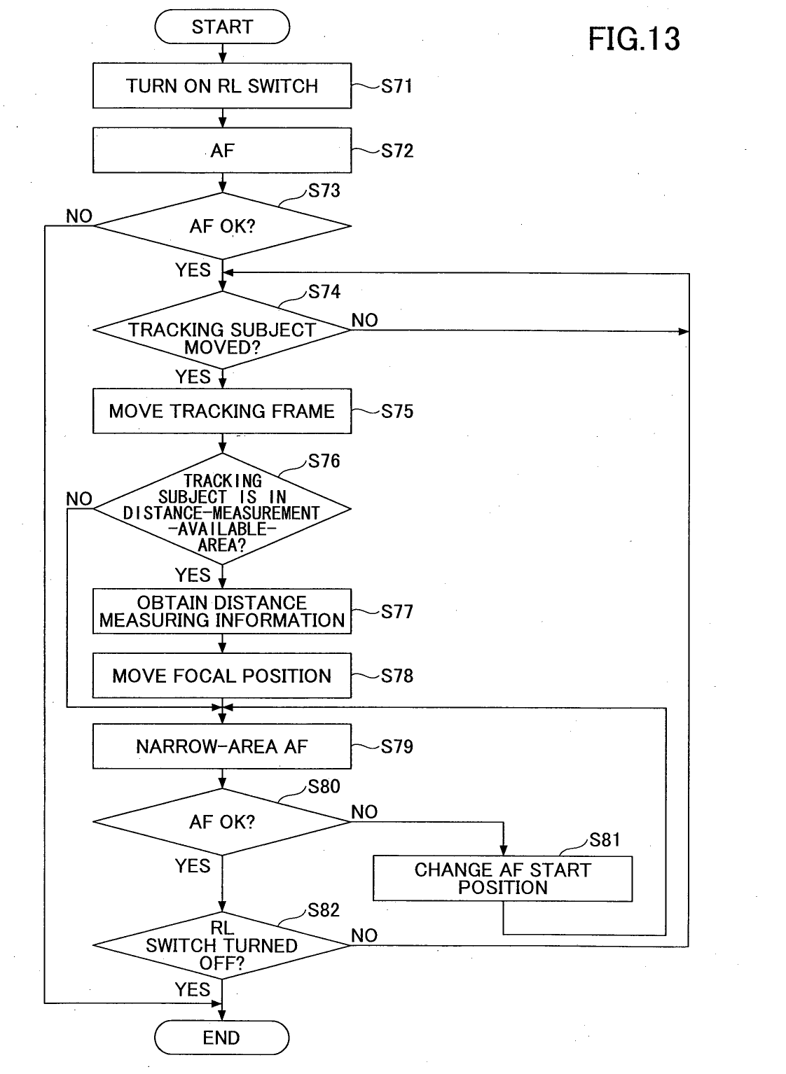

One example of the tracking AF procedure according to the embodiment 4 including a specific method of determining by using the focal length of the camera lenses whether to use a distance measuring result of the distance measuring sensor will now be described using a flowchart. FIG. 13 is a flowchart showing one example of the tracking AF procedure according to the embodiment 4.

Specifically, as shown in FIG. 13, first, as a result of the RL switch SW1 being half pressed (step S71) (in FIG. 13, “turn on RL switch” for the sake of convenience), AF is carried out on a central area (the narrow-area AF area) of the screen (step S72). Then, after the focusing operation is carried out, it is determined whether the AF result is successful (step S73).

In a case where the AF result is successful (step S73 YES), the subject in the narrow-area AF area is registered as a tracking target, and tracking AF for the tracking target is started. After the starting of tracking AF, it is determined whether the tracking subject has moved (step S74). In a case where the tracking subject has moved (step S74 YES), the flow proceeds to a process of moving the tracking frame (or AF frame) for and focusing on the tracking subject which has moved.

Specifically, first, the tracking frame (or AF frame) is moved to the position where the tracking target has moved (step S75). After that, focusing is carried out for the tracking target which has moved. At this time, it is determined whether the position of the tracking subject which has moved on the screen is a position for which the distance to the tracking subject can be measured by the distance sensor. That is, it is determined whether the tracking subject is within the distance-measurement-available-area 93 (see FIG. 11) (step S76). In a case where the tracking subject is within the distance-measurement-available-area 92 (step S76 YES), AF using a distance measuring result of the distance measuring sensor is carried out. Specifically, a distance measuring result is obtained by the distance measuring sensor corresponding to the area of the tracking target which has moved (step S77), and the tracking subject is focused as a result of the focus of the camera lenses being moved to the position of the distance measuring result along optical axis direction (step S78).

After the finish of step S78, AF is carried out (step S79). In a case where the tracking subject is not within the distance-measurement-available-area (step S76 NO), AF is carried out only using narrow-area AF without using a distance measuring result of the distance measuring sensor (step S79). In the case of the process of not using a distance measuring result of the distance measuring sensor, the distance measuring operation of the distance measuring sensor itself may be stopped or may be continued.

Next, it is determined whether the result of AF carried out in step S79 is successful (step S80). In a case where the AF result is not successful (step S80 NO), the AF start position is moved in the optical axis direction in which the in-focus position is expected to exist, for example (step S81), flow proceeds to step S79, and AF is carried out again.

In a case where the AF result is successful (step S80 YES), it is determined whether half pressing of the RL switch SW1 has been broken (step S82) (in FIG. 13, “RL switch turned off?”, for the sake of convenience). It is noted that determination as to whether half pressing of the RL switch SW1 has been broken is carried out as follows. That is, in a case where the finger of the user has been removed from the RL switch SW1 or has pressed the switch SW1 completely, it is determined that half pressing of the RL switch SW1 has been broken. In a case where the half pressing of the switch SW1 has not been broken (step S82 NO), the flow returns to step S74. In a case where the half pressing of the switch SW1 has been broken (step S82 YES), or in a case where the AF result is not successful (step S73 NO), the flow is then finished. In a case where the tracking subject has not moved on the screen (step S74 NO), step S74 is carried out again.

According to the embodiment 4, as a result of carrying out the above-described process, it is possible to maximize the number of situations to carry out tracking AF using a distance measuring result even when using a camera having any focal length and using a distance measuring sensor having any focal length.

### Tracking AF Procedure

### Embodiment 5

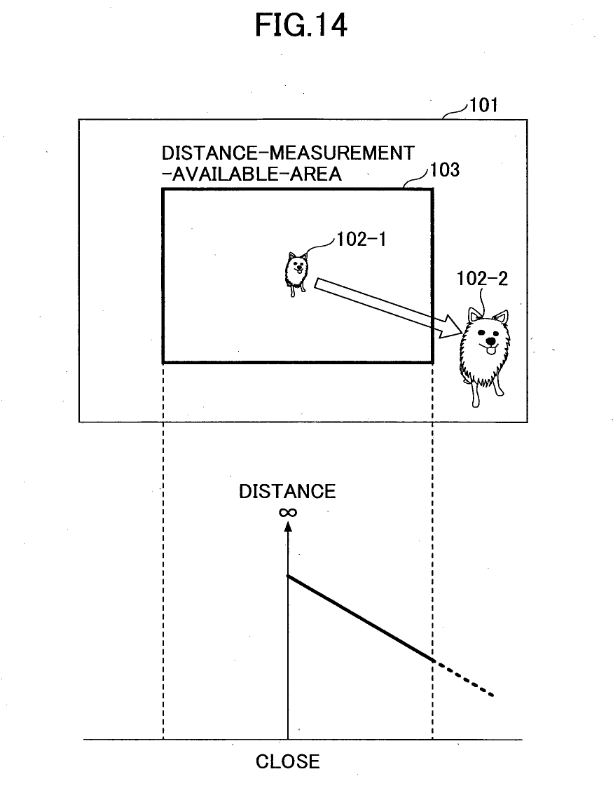

Next, the tracking AF procedure according to the embodiment 5 of the present invention will be described using a flowchart. According to the embodiment 5, a distance measuring result is estimated at a time of tracking AF using a focal length of the camera lenses and a position of a tracking subject on the screen. FIG. 14 illustrates a method of estimating a distance measuring result.

As also described above for the embodiment 3, there may be a case where it is not possible to carry out distance measuring for the entire area of the angle of view at the WIDE end in a camera in which it is possible to carry out zooming to a focal length corresponding to high magnification. In this case, it is impossible to carry out distance measuring at a peripheral area (edge) of the screen. According to the embodiment 4 described above, for example, a distance measuring result is not used in a case where a tracking subject has moved to an area (peripheral area or edge) for which distance measuring is impossible. Instead, according to the embodiment 5, a distance to a tracking subject is estimated when the tracking subject is in an area outside the distance-measurement-available-area 93 (see FIG. 11) based on distance information for the tracking subject obtained when the tracking subject has been within the distance-measurement-available-area 93, in a case where the tracking subject has moved to the area (a distance-measurement-unavailable-area) outside the distance-measurement-available-area 93. Then, the estimated distance is used as the distance measuring result of the tracking subject, and thus, it is possible to maximize the number of situations of being able to use the distance measuring results.

Specifically, as shown in FIG. 14, the estimation of the distance measuring result is carried out as follows. That is, in an entire photographing area 101, a position of a tracking subject 102-1 is obtained at the center of the screen. After that, the distance to the tracking subject which is moving is measured at fixed intervals. Then, when the tracking subject has moved to an area (the distance-measurement-unavailable-area) outside the distance-measurement-available-area 103 (for example, when the tracking subject 102-1 has moved to be the position of the tracking subject 102-2 in FIG. 14), distance information following this time is estimated based on the distance information of the tracking subject thus obtained preceding this time. That is, according to the embodiment 5, using, for example, linear interpolation, the distance information following the time is estimated based on the distance information obtained when the tracking subject 102-1 has been within the distance-measurement-available-area 103 at the respective two points, i.e., the distance at the time tracking of the tracking subject 102-1 has been initially started and the distance at the time immediately before the tracking subject has moved to the distance-measurement-unavailable-area.

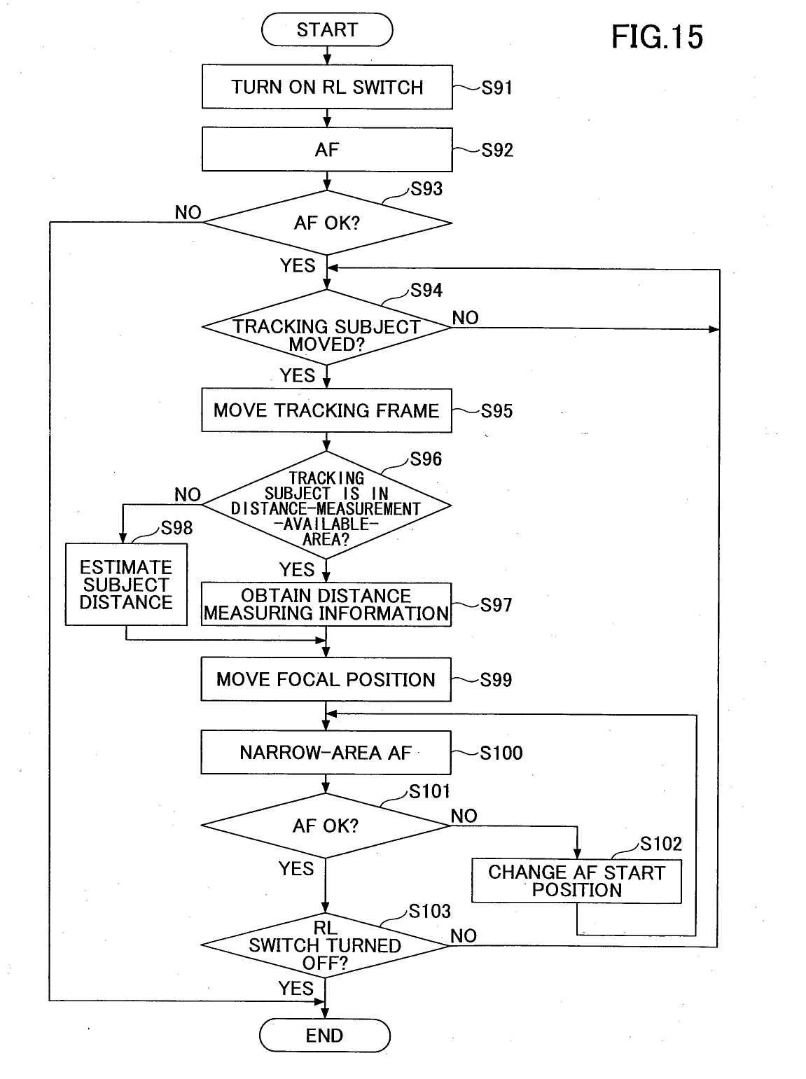

FIG. 15 is a flowchart showing one example of the tracking AF procedure according to the embodiment 5. Specifically, as shown in FIG. 15, first, as a result of the RL switch SW1 being half pressed (step S91) (in FIG. 15, “turn on RL switch” for the sake of convenience), AF is carried out on a central area (the narrow-area AF area) of the screen (step S92). Then, after the focusing operation is carried out, it is determined whether AF result is successful (step S93).

In a case where the AF result is successful (step S93 YES), the subject in the narrow-area AF area is registered as a tracking target, and tracking AF for the tracking target is started. After the starting of tracking AF, it is determined whether the tracking subject has moved on the screen (step S94). In a case where the tracking subject has moved on the screen (step S94 YES), the flow proceeds to a process of moving the tracking frame (or AF frame) for and focusing on the tracking subject which has moved.

Specifically, first, the tracking frame (or AF frame) is moved to the position where the tracking target has moved (step S95). After that, focusing is carried out for the tracking target which has moved. At this time, it is determined whether the position of the tracking subject is a position for which the distance to the tracking subject can be measured. That is, it is determined whether the tracking subject is within the distance-measurement-available-area 103 (step S96). In a case where the tracking subject is within the distance-measurement-available-area 103 (step S96 YES), AF using a distance measuring result of the distance measuring sensor is carried out. Specifically, a distance measuring result is obtained by the distance measuring sensor corresponding to the area of the tracking target which has moved (step S97).

In a case where the tracking subject is not within the distance-measurement-available-area 103 (step S96 NO), a distance measuring result of the distance measuring sensor is not used, and the above-described estimation of the distance to the tracking subject is carried out (step S98). After the finish of step S97 or step S98, the tracking subject is focused as a result of the focus of the camera lenses being moved in the optical axis direction according to the result of step S97 or the result of step S98 (step S99), and AF (narrow-area AF) is carried out (step S100).

Next, it is determined whether the result of AF carried out in step S99 is successful (step S101). In a case where the AF result is not successful (step S101 NO), the AF start position is moved in an optical axis direction in which the in-focus position is expected to exist, for example (step S102), flow proceeds to step S100, and AF is carried out again.

In a case where the AF result is successful (step S101 YES), it is determined whether half pressing of the RL switch SW1 has been broken (step S103) (in FIG. 15, “RL switch turned off?”, for the sake of convenience). It is noted that determination as to whether half pressing of the RL switch SW1 has been broken is carried out as follows. That is, in a case where the finger of the user has been removed from the RL switch SW1 or has pressed the switch SW1 completely, it is determined that half pressing of the RL switch SW1 has been broken. In a case where the half pressing of the switch SW1 has not been broken (step S103 NO), the flow returns to step S94. In a case where the half pressing of the switch SW1 has been broken (step S103 YES), or in a case where the AF result is not successful (step S93 NO), the flow is then finished. In a case where the tracking subject has not moved on the screen (step S94 NO), step S94 is carried out again.

According to the embodiment 5, as a result of carrying out the above-described process, it is possible carry out tracking AF at the same speed even in the distance-measurement-unavailable-area as that in the distance-measurement-available-area.

### Tracking AF Procedure

### Embodiment 6

Next, the tracking AF procedure according to the embodiment 6 of the present invention will be described. For the respective embodiments described above, the cases where the AF frame (i.e., the above-mentioned narrow-area AF area or tracking frame) is automatically moved according to the automatic tracking process (in tracking AF). However, embodiments of the present invention are not limited thereto, and, for example, even in a case where the AF frame is moved manually, processes similar to those in the respective embodiments described above are carried out. Therefore, the case where the AF frame is moved manually will now be described as the embodiment 6 of the present invention, in detail.

### <Manual Movement of AF Frame>

For example, by pressing any one of the up, down, left and right switches SW10, SW13, SW12 and SW11 shown in FIG. 1C, it is possible to manually move the AF frame (narrow-area AF area 73-1 shown in FIG. 6, for example) currently displayed at the center of the screen. Therefore, according to the embodiment 6, by moving the AF frame to any position on the screen, and by pressing the OK switch SW7 shown in FIG. 1C, the AF frame is fixed at the position.

Further, in a case where the moved AF frame is in the area outside the distance-measurement-available-area (93 or 103), narrow-area AF (contrast AF) is carried out as in the embodiment 4 described above.

Further, for example, in a case where the display part, i.e., the LCD monitor 21, has the input/output function such as that of the touch panel or such, as a result of the user touching any subject displayed on the screen of the LCD monitor 21 by his or her finger, it is also possible to move the AF frame to the subject. In this case, in a case where the moved AF frame is in the area outside the distance-measurement-available-area (93 or 103), narrow-area AF (contrast AF) is carried out as in the embodiment 4 described above.

According to the embodiment 6, by carrying out the above-described process, it is possible to prevent a situation in which focusing on a subject becomes impossible by the subject being outside the distance-measurement-available-area (93 or 103) of the distance measuring sensor which causes the distance measurement to be unavailable, by carrying out narrow-area AF (contrast AF), even in a case where the AF frame enters the area outside the distance-measurement-available-area as a result of zooming operation, as a result of automatic tracking operation, or as a result of the AF frame being moved manually, for example. It is noted that the above-mentioned embodiments 1 through 6 may be appropriately combined together.

As described above, according to the embodiments of the present invention, even in a case where the two-dimensional sensor is used as the distance measuring sensor, it is possible to prevent a situation in which focusing on a subject becomes impossible by the subject being outside the distance-measurement-available-area of the distance measuring sensor which causes the distance measurement to be unavailable, by using contrast AF when the subject moves outside the distance-measurement-available-area. Therefore, even when the distance to the tracking subject changes sharply during tracking AF, it is possible to continue to focus on the subject in a real-time manner.

The present invention is not limited to the specifically disclosed embodiments, and variations and modifications may be made without departing from the scope of the present invention.

The present application is based on Japanese Priority Patent Application No. 2011-006939 filed Jan. 17, 2011 and Japanese Priority Patent Application No. 2011-217683 filed Sep. 30, 2011, the entire contents of which are hereby incorporated herein by reference.

1. An imaging apparatus comprising:
an imaging part including an image sensor;
a focusing control part configured to drive an optical system included in the imaging part, input an image of a subject into a light reception part of the image sensor, obtain an automatic focusing evaluation value based on the image obtained through the imaging part and carry out focusing control; and
a distance measuring part configured to measure a distance to the subject by using plural two-dimensional sensors, wherein
the focusing control part carries out the focusing control in a case where a position of the subject is outside a distance-measurement-available-area of the distance measuring part.

2. The imaging apparatus as claimed in claim 1, wherein
the focusing control part is configured to determine whether to use a distance measuring result obtained by the distance measuring part according to a focal length.

3. The imaging apparatus as claimed in claim 1, wherein
the focusing control part is configured to carry out the focusing control in a case where a position of the subject has moved from inside of the distance-measurement-available-area of the distance measuring part to outside of the distance-measurement-available-area of the distance measuring part.

4. The imaging apparatus as claimed in claim 3, wherein
the focusing control part is configured to, in a case where a position of the subject is inside the distance-measurement-available-area of the distance measuring part, move a focal position of the optical system to a position of a distance measured by the distance measuring part, and carry out the focusing control based on the moved focal position.

5. The imaging apparatus as claimed in claim 1, wherein
the distance measuring part is configured to, in a case where a position of the subject has moved from inside of the distance-measurement-available-area of the distance measuring part to outside of the distance-measurement-available-area of the distance measuring part, estimate the position of the subject based on the positions of the subject inside the distance-measurement-available-area of the distance measuring part.

6. An imaging method comprising:
taking an image of a subject using an imaging part including an image sensor;
driving an optical system included in the imaging part, inputting an image of the subject into a light reception part of the image sensor, obtaining an automatic focusing evaluation value based on the image obtained through the imaging part and carrying out focusing control; and
measuring a distance to the subject by using plural two-dimensional sensors, wherein
the focusing control is carried out in a case where a position of the subject is outside a distance-measurement-available-area of the distance measuring part.

7. An imaging program, which when executed by one or plural processors, performs the imaging method claimed in claim 6.

8. A computer readable information recording medium storing the program claimed in claim 7.
